(19) United States
(12) Patent Application Publication
(10) Pub. No.: US 2023/0252003 A1
(43) Pub. Date: Aug. 10, 2023

(54) PARALLEL DATA STORE SYSTEM, COMPUTER-READABLE RECORDING MEDIUM STORING PROGRAM, AND PARALLEL DATA STORE METHOD

(71) Applicant: Fujitsu Limited, Kawasaki-shi (JP)

(72) Inventor: HIROKI OHTSUJI, Yokohama (JP)

(73) Assignee: Fujitsu Limited, Kawasaki-shi (JP)

(21) Appl. No.: 17/988,354

(22) Filed: Nov. 16, 2022

(30) Foreign Application Priority Data
Feb. 10, 2022 (JP) 2022-019691

(51) Int. Cl. G06F 16/18; G06F 11/34

(52) U.S. Cl. CPC G06F 16/1858; G06F 11/3419

(57) ABSTRACT

A management server in a parallel data system stores a correspondence-relationship between a first response-time for communication-processing and a second response-time for data-processing, executed by each of a plurality of data servers in relation to first processing by a client node, acquires, at a time of execution of second processing by the client node, a third response-time desired for communication-processing and a fourth response-time desired for data-processing, which are related to second processing, in each of a plurality of data servers, based on the first response-time and the second response-time, determines combinations of the data servers used to execute the second processing, based on the third response-time and fourth response-time, and selects a combination that satisfies a response-time to be satisfied by the second processing and that includes a smallest number of processor cores allocated to the communication-processing of a data server, among the determined combinations.

### CROSS-REFERENCE TO RELATED APPLICATION

This application is based upon and claims the benefit of priority of the prior Japanese Patent Application No. 2022-19691, filed on Feb. 10, 2022, the entire contents of which are incorporated herein by reference.

### FIELD

The embodiment discussed herein is related to a parallel data store system, a computer-readable recording medium storing a program, and a parallel data store method.

### BACKGROUND

A parallel data store is a system configured by a plurality of computers (for example, nodes), stores data, and provides read and write access. For each communication path, each client and each server perform polling processing that exclusively uses a central processing unit (CPU) core in order to increase a speed of communication.

Japanese Laid-open Patent Publication No. 2010-277289 is disclosed as related art.

### SUMMARY

According to an aspect of the embodiments, a parallel data store system includes a plurality of data servers, and a management server coupled to the plurality of data servers and a client node, and the management server including a first memory, and a first processor coupled to the first memory and configured to store a correspondence relationship between a first response time desired for communication processing and a second response time desired for data processing, executed by each of the plurality of data servers in relation to first processing by the client node, acquire, at a time of execution of second processing different from the first processing by the client node, a third response time desired for communication processing and a fourth response time desired for data processing, which are related to second processing, in each of the plurality of data servers, based on the first response time and the second response time, determine combinations of the data servers used to execute the second processing, based on the acquired third response time and fourth response time, and select a combination that satisfies a response time to be satisfied by the second processing and that includes a smallest number of processor cores allocated to the communication processing of a data server of the plurality of data servers, among the determined combinations.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a parallel data store system in a related example;

FIG. 2 is a diagram for describing an interrupt model and a polling model in the parallel data store system as the related example;

FIG. 3 is a diagram for describing an increase in the number of polling processing in the polling model illustrated in FIG. 2;

FIG. 4 is a block diagram schematically illustrating a configuration example of a parallel data store system according to an embodiment;

FIG. 5 is a block diagram schematically illustrating an example of a hardware configuration of a management server illustrated in FIG. 4;

FIG. 6 is a diagram for briefly describing data arrangement processing in the parallel data store system illustrated in FIG. 4;

FIG. 7 is a diagram for describing details of the data arrangement processing in the parallel data store system illustrated in FIG. 4;

FIG. 8 is a block diagram schematically illustrating an example of a software configuration of the parallel data store system illustrated in FIG. 4;

FIG. 9 is a diagram exemplifying a performance prediction map in the parallel data store system illustrated in FIG. 4;

FIG. 10 is a diagram for describing performance prediction processing in the parallel data store system illustrated in FIG. 4;

FIG. 11 is a table illustrating a relationship between a request and a load increase in the parallel data store system illustrated in FIG. 4;

FIG. 12 is a flowchart for describing initial processing in the parallel data store system illustrated in FIG. 4;

FIG. 13 is a flowchart for describing processing of second or subsequent time in the parallel data store system illustrated in FIG. 4;

FIG. 14 is a flowchart for describing data arrangement determination processing in the parallel data store system illustrated in FIG. 4;

FIG. 15 is a table exemplifying a data server having a sufficient free space in the parallel data store system; and

FIG. 16 is a flowchart for describing performance prediction processing in the parallel data store system illustrated in FIG. 4.

### DESCRIPTION OF EMBODIMENTS

The CPU core is consumed for each communication path. When the number of clients or the number of servers increases, there is a risk that the processing may not be executed or the processing may compete with each other and a performance may be degraded.

### [A] Related Example

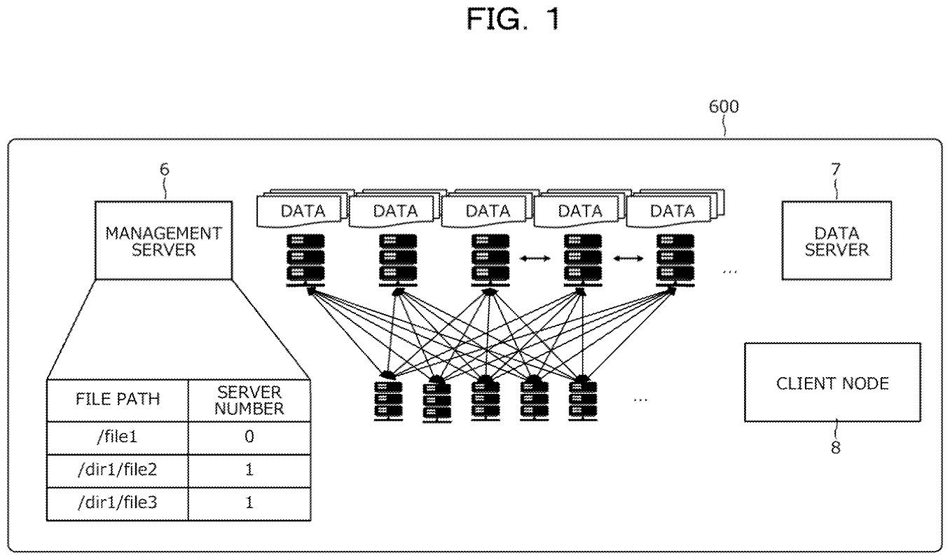

FIG. 1 is a diagram for describing a parallel data store system 600 in a related example.

The parallel data store system 600 includes a management server 6, a plurality of data servers 7, and a plurality of client nodes 8.

Pieces of data are distributed and arranged in the plurality of data servers 7. Basically, the client node 8 accesses data by communicating with all of the data servers 7. The management server 6 holds a location of a data server 7 where a file is stored in a table format. In a table in which a file path and a server number are associated with each other, the management server 6 adds a row when a file is written and refers to each row when the file is read.

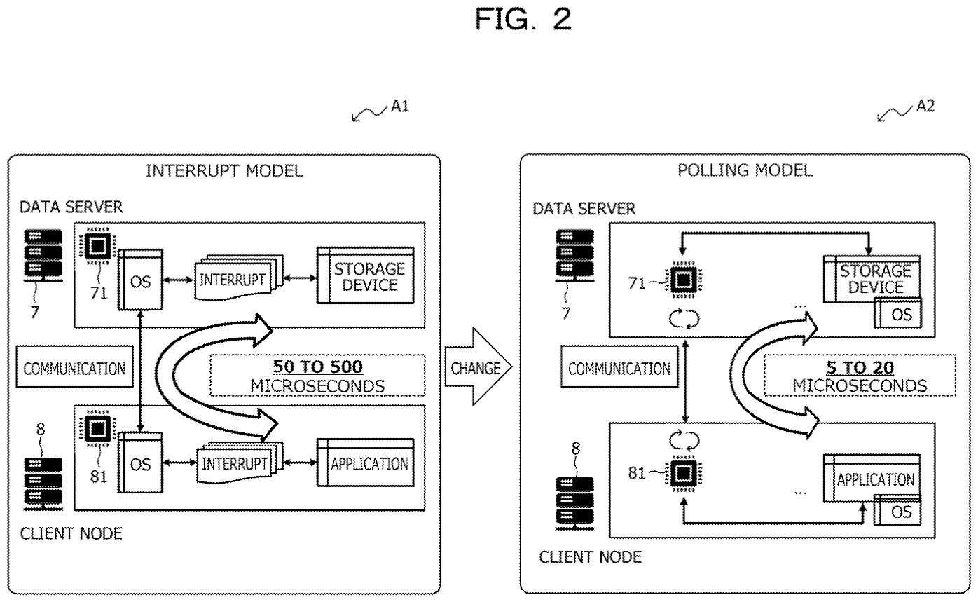

FIG. 2 is a diagram for describing an interrupt model and a polling model in the parallel data store system 600 as the related example.

As indicated by a reference sign A1, in an interrupt model, communication to the data server 7 occurs in a CPU core 81 of the client node 8 by an interrupt from an application to an operating system (OS). In a CPU core 71 of the data server 7, data is read by an interrupt from the OS to a storage device, and the data is returned by communication to the client node 8. A round-trip communication time between the client node 8 and the data server 7 is about 50 to 500 microseconds.

As indicated by a reference sign A2, in order to bring out a performance of a high-speed storage device, a software design of the interrupt model is changed to a polling model. A combination of the CPU cores 71 and 81 between the client node 8 and the data server 7 is dedicatedly allocated to one communication path, and polling processing is performed to speed up the communication. Accordingly, the round-trip communication time is shortened to about 5 to 20 microseconds.

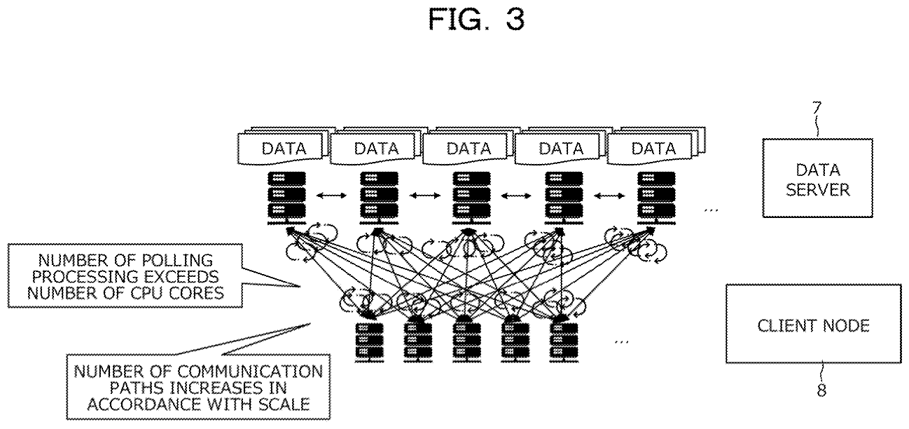

FIG. 3 is a diagram for describing an increase in the number of polling processing in the polling model illustrated in FIG. 2.

Due to an increase in a scale of a data system, the number of communication paths increases. Since pieces of data are uniformly distributed to all of the data servers 7, communication occurs from the client node 8 to all of the data servers 7. The number of desired polling processing is increased by the number of servers x the number of polling. When polling is performed in excess of the number of CPU cores 71 and 81, an access performance is degraded due to competition.

As described above, since the number of communication paths increases due to the increase in the scale of the data system, the number of polling processing increases and the performance is degraded.

### [B] Embodiment

An embodiment of techniques capable of improving a communication speed in a parallel data store will be described below with reference to the drawings. The embodiment described below is merely illustrative and is not intended to exclude employment of various modification examples or techniques that are not explicitly described in the embodiment. For example, the present embodiment may be implemented by variously modifying the embodiment without departing from the gist of the embodiment. Each of the drawings is not intended to indicate that only the elements illustrated therein are included. Thus, other functions or the like may be included.

Since the same reference sign denotes the same element in the drawings, the description thereof is omitted below.

### [B-1] Configuration Example

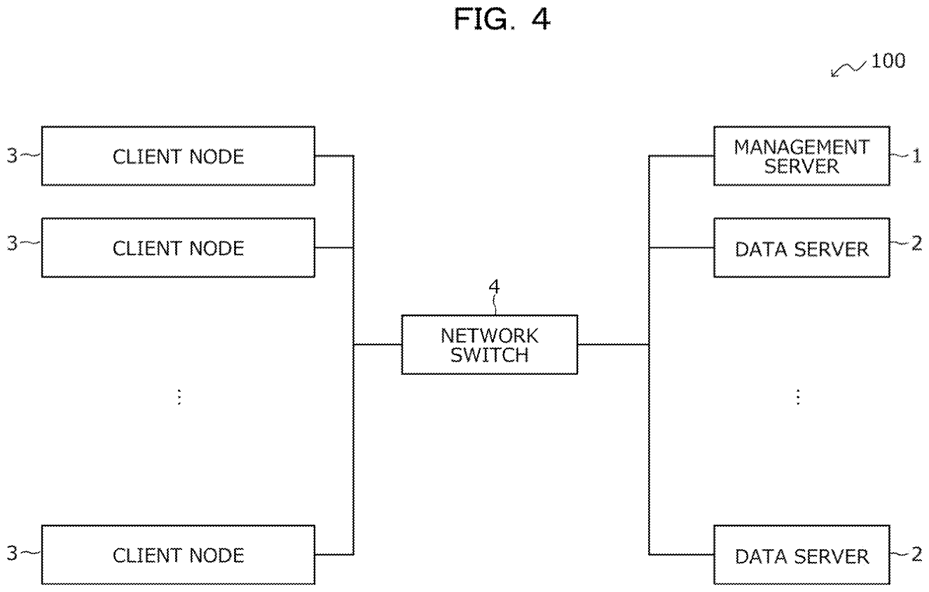

FIG. 4 is a block diagram schematically illustrating a configuration example of a parallel data store system 100 according to the embodiment.

The parallel data store system 100 is, for example, a machine learning system that desires high-speed data access, and open source software (OSS) such as Lustre used in a supercomputer or the like is executed in the parallel data store system 100. The parallel data store system 100 includes a management server 1, a plurality of data servers 2, a plurality of client nodes 3, and a network switch 4.

The network switch 4 couples the management server 1 and the plurality of data servers 2, with the client nodes 3 so as to communicate with each other.

The management server 1 determines data arrangement in each data server 2. A function as the management server 1 may be provided in at least one of the plurality of data servers 2.

Each of the plurality of data servers 2 holds data accessed from the client node 3.

Each of the plurality of client nodes 3 accesses each data server 2 to acquire data.

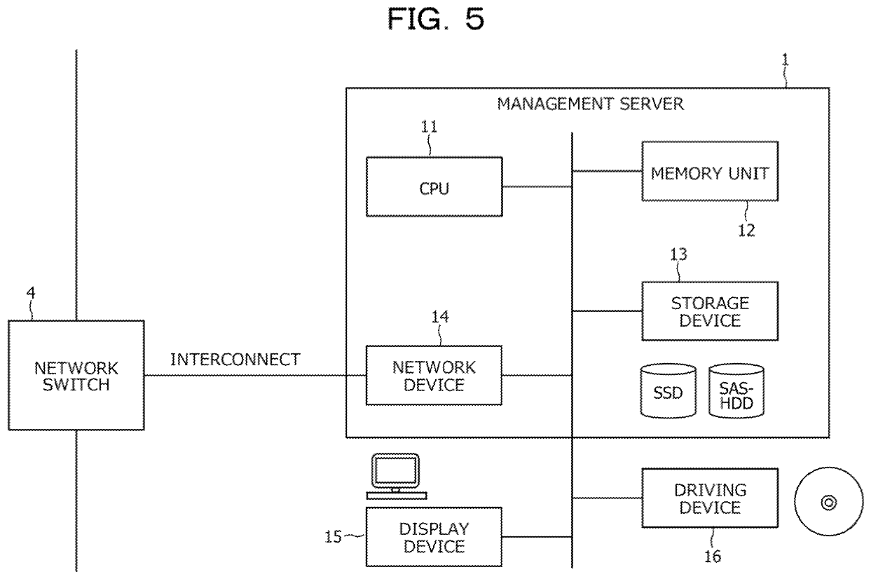

FIG. 5 is a block diagram schematically illustrating an example of a hardware configuration of the management server 1 illustrated in FIG. 4.

The management server 1 includes a CPU 11, a memory unit 12, a storage device 13, and a network device 14. The management server 1 is coupled to a display device 15 and a driving device 16. The data server 2 and the client node 3 illustrated in FIG. 4 may have an example of the hardware configuration similar to that of the management server 1.

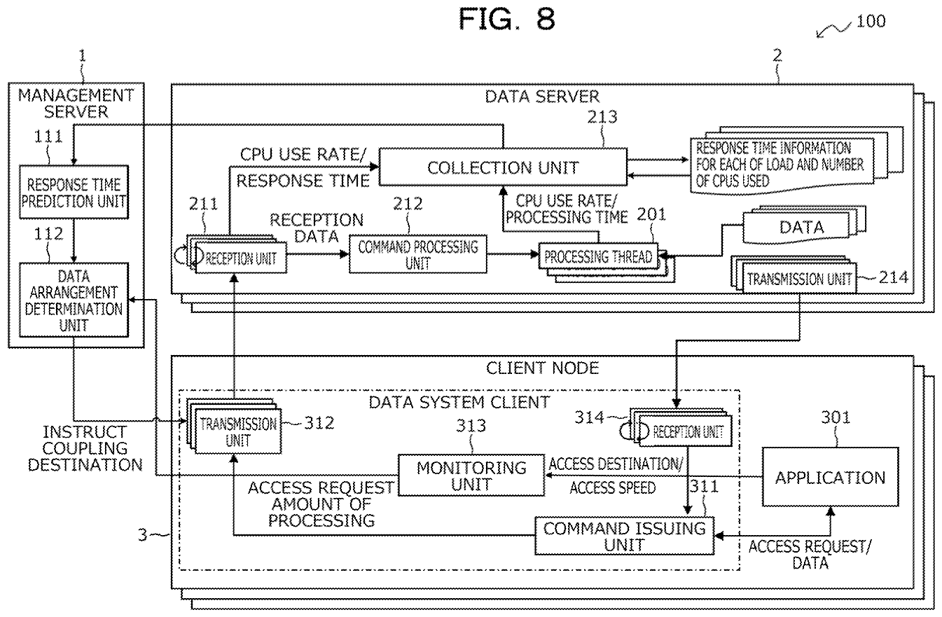

The CPU 11 is an example of a processor, and is a processing device that performs various controls and computations. By executing the OS and programs loaded to the memory unit 12, the CPU 11 achieves various functions. Details of the processing by the CPU 11 will be described later with reference to FIG. 8 and the like.

A device for controlling operations of the entire management server 1 is not limited to the CPU 11 and may be, for example, any one of an MPU, a DSP, an ASIC, a PLD, and an FPGA. The device for controlling the operations of the entire management server 1 may be a combination of two or more kinds of the CPU, the MPU, the DSP, the ASIC, the PLD, and the FPGA. “MPU” is an abbreviation for “microprocessor unit”. “DSP” is an abbreviation for “digital signal processor”. “ASIC” is an abbreviation for “application-specific integrated circuit”. “PLD” is an abbreviation for “programmable logic device”.

The memory unit 12 is an example of a storage unit and includes, for example, a read-only memory (ROM), a random-access memory (RAM), and the like. Programs such as a Basic Input/Output System (BIOS) may be written in the ROM of the memory unit 12. Software programs in the memory unit 12 may be appropriately loaded onto and executed by the CPU 11. The RAM of the memory unit 12 may be used as a memory for temporary recording or as a working memory.

The storage device 13 is a storage device having a large storage capacity, and for example, a dynamic random-access memory (DRAM), a solid-state drive (SSD), a storage class memory (SCM), or a serial attached small computer systems interface (SCSI)-hard disk drive (SAS-HDD) may be used.

The network device 14 is an interface for enabling communication with an external device such as the network switch 4.

The display device 15 is a liquid crystal display, an organic light-emitting diode (OLED) display, a cathode ray tube (CRT), an electronic paper display, or the like and displays various kinds of information for, an operator or the like. The display device 15 may be combined with an input device. For example, the display device 15 may be a touch panel.

The driving device 16 is configured so that a recording medium may be mounted. The driving device 16 is configured to be able to read information recorded on the recording medium in a state in which the recording medium is mounted. In this example, the recording medium is portable. For example, the recording medium is a flexible disk, an optical disc, a magnetic disk, a magneto-optical disk, a semiconductor memory, or the like.

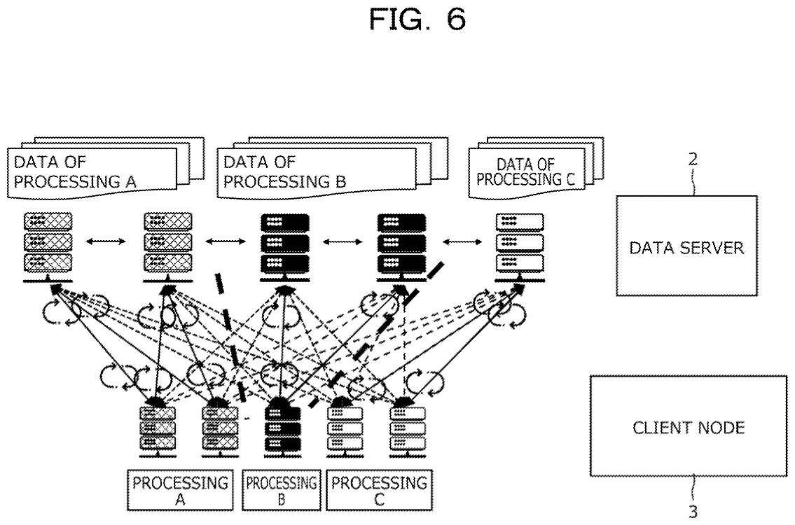

FIG. 6 is a diagram for briefly describing data arrangement processing in the parallel data store system 100 illustrated in FIG. 4.

Even when the scale of the parallel data store system 100 is expanded, the management server 1 selects data arrangement that may suppress an increase in the number of communication paths. The management server 1 does not uniformly distribute data but allocates a data server 2 of a data arrangement destination for each processing so that the number of couplings does not increase. For example, the management server 1 allocates the number of data servers 2 sufficient to provide the access performance requested for each processing issued from the client node 3.

In the example illustrated in FIG. 6, for two client nodes 3 that issue the processing A, pieces of data of processing A are arranged in two data servers 2. For one client node 3 that issues processing B, pieces of data of the processing B are arranged in two data servers 2. For two client nodes 3 that issue processing C, data of the processing C is arranged in one data server 2.

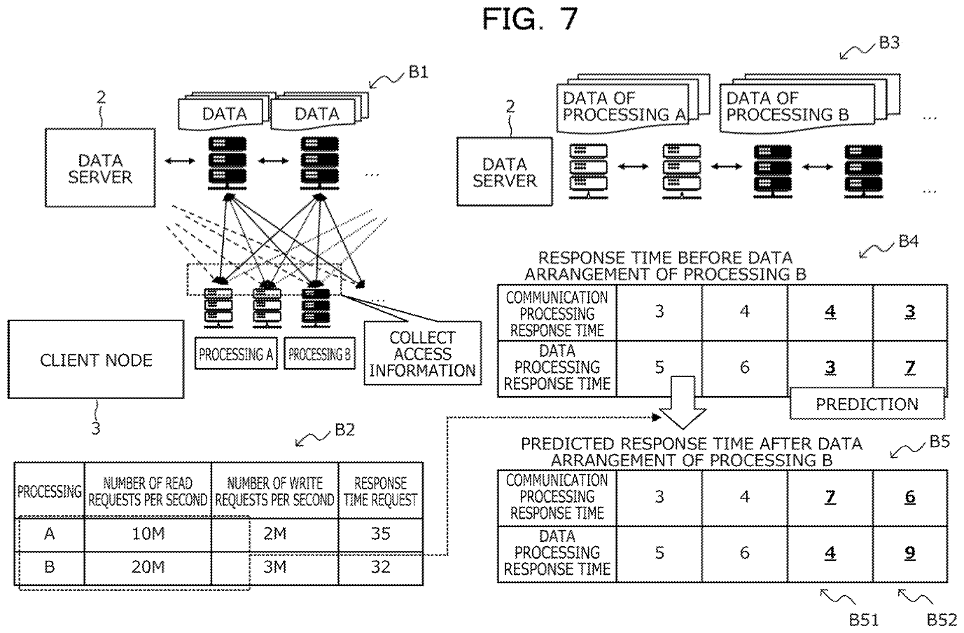

FIG. 7 is a diagram for describing details of data arrangement processing in the parallel data store system 100 illustrated in FIG. 4.

The management server 1 limits a data server 2 as an arrangement destination of data to be used for each processing. Accordingly, by reducing the number of communications desired when certain processing is executed, the number of polling processing is reduced so that the performance is not degraded even when the number of data servers 2 increases.

As indicated by a reference sign B1, the management server 1 collects access information between the client node 3 and the data server 2 at the time of an initial execution of target processing.

As indicated by a reference sign B2, in the access information, the number of read requests per second, the number of write requests per second, and a response time request (unit is, for example, microsecond) are associated with each other for each processing. The access information indicated by the reference sign B2 may be held in the management server 1 from the beginning. The access information may be acquired by dummy data or may be acquired by an actual operation in the parallel data store system 100.

As indicated by a reference sign B3, the management server 1 determines a data arrangement destination when the target processing writes data next.

Based on the access information, the management server 1 predicts a performance estimate of the data server 2 and sets the data server 2 as an arrangement destination that satisfies an access request performance requested by the processing.

A reference sign B4 indicates a communication processing response time and a data processing response time of each data server 2 before data arrangement of the processing B. A reference sign B5 indicates a communication processing response time and a data processing response time of each data server 2 after the data arrangement of the processing B.

In a table indicated by the reference sign B5, a sum of the communication processing response time (7+6) and the data processing response time (4+9) is 26 in two right columns (see reference signs B51 and B52) indicating predicted response times of the data servers 2 which are data arrangement candidates for the processing B. For example, 25 that is the predicted response time is equal to or shorter than 32 that is a response time request of the processing B in the access information.

FIG. 8 is a block diagram schematically illustrating an example of a software configuration of the parallel data store system 100 illustrated in FIG. 4.

The client node 3 functions as a command issuing unit 311, a transmission unit 312, a monitoring unit 313, and a reception unit 314.

The command issuing unit 311 transmits an access request issued from an application 301 (for example, middleware or a library that accesses data) to the transmission unit 312. The command issuing unit 311 transmits data from the data server 2 received from the reception unit 314 to the application 301.

The transmission unit 312 transmits the access request received from the command issuing unit 311 to the data server 2.

At an initial execution of each processing, the monitoring unit 313 acquires an access destination and an access speed request performance from the application 301. The monitoring unit 313 transmits the access destination and the access speed request performance to the management server 1 as an access request amount for processing.

The reception unit 314 transmits the data received from the data server 2 to the command issuing unit 311.

The data server 2 functions as a reception unit 211, a command processing unit 212, a collection unit 213, and a transmission unit 214.

The reception unit 211 transmits an access request received from the client node 3 to the command processing unit 212 as reception data. The reception unit 211 transmits a CPU use rate and a response time in the reception unit 211 to the collection unit 213.

The command processing unit 212 processes the reception data in a processing thread 201 thereby accessing the data.

The collection unit 213 receives the CPU use rate and the response time of the reception unit 211 and receives a CPU use rate and a response time of the processing thread 201. As a result, the collection unit 213 collects load information and response time information for each number of CPUs used, and transmits the collected information to the management server 1.

The transmission unit 214 transmits data read by the processing thread 201 to the client node 3.

The management server 1 functions as a response time prediction unit 111 and a data arrangement determination unit 112.

Based on the load information and the response time information for each number of CPUs used received from the data server 2, the response time prediction unit 111 predicts a response time (for example, a server performance prediction value) in a case where each data server 2 is used.

Based on the load information received from the data server 2 and the server performance prediction value predicted by the response time prediction unit 111, the data arrangement determination unit 112 determines the data server 2 as the data arrangement destination for the target processing. When the target processing is executed for the second or subsequent time, the data arrangement determination unit 112 instructs the transmission unit 312 of the client node 3 to use the data server 2 as the data arrangement destination as a coupling destination.

For example, each of the plurality of data servers 2 acquires a first response time desired for communication processing and a second response time desired for data processing, executed by the data server in relation to first processing (for example, processing A) by the client node 3. At the time of execution of second processing (for example, processing B) different from the first processing by the client node 3, the management server 1 acquires a third response time desired for communication processing and a fourth response time desired for data processing, which are related to the second processing, in each of the plurality of data servers 2 based on the first response time and the second response time. Based on the acquired third response time and fourth response time, the management server 1 determines combinations of the data servers used to execute the second processing. Among the determined combinations, the management server 1 selects a combination that satisfies a response time to be satisfied by the second processing and that has the smallest number of processor cores allocated to the communication processing of the data server. The communication processing may be communication processing by polling that exclusively uses the processor core.

Each of the plurality of data servers 2 may acquire the number of requests per unit time and a processor use rate when the second processing is executed for the first time. When the second processing is executed for the second time, the management server 1 may acquire a third response time desired for communication processing and a fourth response time desired for data processing related to the second processing in each of the plurality of data servers 2 based on the first response time, the second response time, the number of requests per unit time, and the processor use rate.

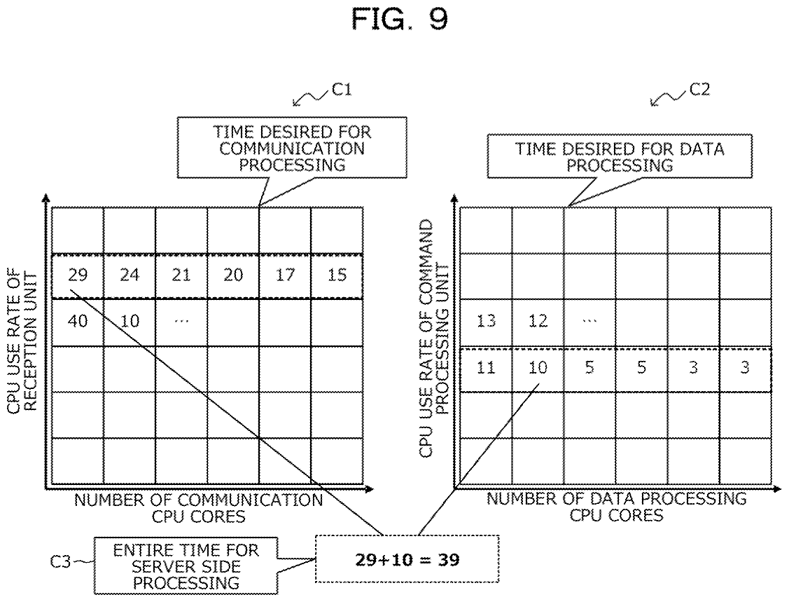

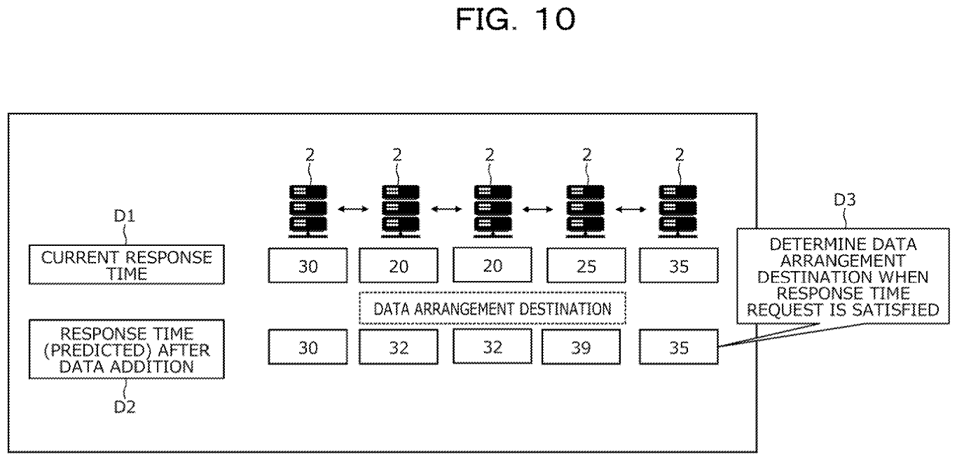

FIG. 9 is a diagram illustrating a performance prediction map in the parallel data store system 100 illustrated in FIG. 4. FIG. 10 is a diagram for describing performance prediction processing in the parallel data store system 100 illustrated in FIG. 4.

The communication processing and the data processing are performed inside the data server 2. For each of the communication processing and the data processing, the response time prediction unit 111 of the management server 1 monitors an allocated resource amount and a CPU load via the collection unit 213 of the data server 2, and acquires a map of the response time.

By referring to the performance prediction map illustrated in FIG. 9, the response time prediction unit 111 calculates a change in the response time in accordance with the increasing load amount. From the collected request information of the processing, the response time prediction unit 111 may predict how the response time of the data server 2 changes when the processing is allocated to the data server 2.

The performance prediction map indicated by a reference sign C1 in FIG. 9 represents a time desired for the communication processing in accordance with the number of communication CPU cores (horizontal axis) and the CPU use rate of the reception unit 211 (vertical axis). The performance prediction map indicated by a reference sign C2 in FIG. 9 represents a time desired for the data processing in accordance with the number of data processing CPU cores (horizontal axis) and the CPU use rate of the command processing unit 212 (vertical axis).

From the performance prediction map indicated by the reference sign C1, the response time prediction unit 111 acquires the time desired for the communication processing in accordance with a communication CPU resource amount and a CPU use rate of the reception unit 211 (29 is selected as an example in FIG. 9). The response time prediction unit 111 acquires the time desired for the data processing in accordance with a data processing CPU resource amount and a CPU use rate of the command processing unit 212 (10 is selected as an example in FIG. 9). As indicated by a reference sign C3 in FIG. 9, the response time prediction unit 111 calculates a sum (39) of the time (29) desired for the communication processing and the time (10) desired for the data processing as the entire time of the processing on the data server 2 side. Although the time is selected from certain CPU use rates on the vertical axis in the performance prediction maps indicated by the reference signs C1 and C2, respectively, the time may be selected from the corresponding CPU use rates due to fluctuations on the vertical axis in practice.

As illustrated in FIG. 10, the data arrangement determination unit 112 of the management server 1 rewrites a current response time indicated by a reference sign D1 to the response time (predicted) after data addition indicated by a reference sign D2 based on the entire time of processing on the data server 2 side calculated by the response time prediction unit 111 using the performance prediction map. As indicated by a reference sign D3 in FIG. 10, when the response time request is satisfied at the response time (predicted) after the data addition, the data arrangement determination unit 112 determines the data server 2 as the data arrangement destination.

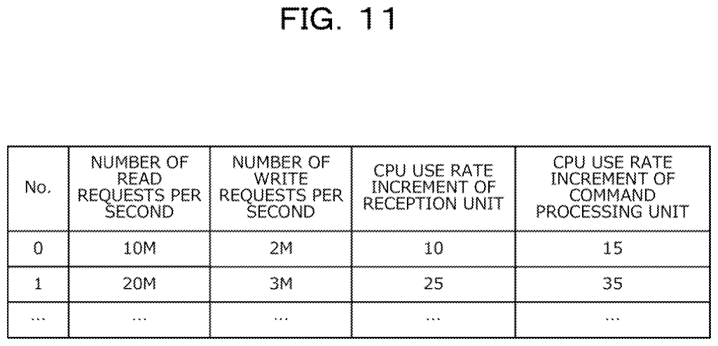

FIG. 11 is a table illustrating a relationship between a request and a load increase in the parallel data store system 100 illustrated in FIG. 4.

As illustrated in FIG. 11, at the time of the initial execution of the target processing, the number of requests per second requested for the target processing and the CPU use rate increment amounts of communication and data processing for the requests are recorded in the table. As illustrated in FIG. 11, for example, in data of No. 0, 10 of the CPU use rate increment of the reception unit 211 and 15 of the CPU use rate increment of the command processing unit 212 are recorded for 10M of the number of read requests per second and 2M of the number of write requests per second.

The CPU use rate increment amount may be obtained by the following (1) or (2).

(1) The CPU use rate increment amount is obtained from the read and write request speeds measured at the time of the initial execution. The request speed may be estimated based on a result value recorded so far.

(2) The CPU use rate increment amount may be obtained by a load rate increment amount in a case where monitoring is performed on the data server 2 side and a request related to the processing is actually made.

Although an accuracy of the above (2) is higher because of actual measurement, the above (1) may be used in a case where a request related to processing other than the reception unit 211 and the command processing unit 212 affects a request related to processing in the reception unit 211 and the command processing unit 212.

Which of (1) and (2) above is used is determined by comparing (the number of requests to be observed)/(the total number of request processing in the target server) with a threshold value T [%]. When (the number of requests to be observed)/(the total number of request processing in the target server) exceeds T, the above (2) is used, otherwise the above (1) is used.

When the processing of the above (2) is successfully performed, the result value is added to the table as illustrated in FIG. 11 representing a relationship between the request and the load increment.

At a start timing of the processing, when the monitored processing performs data writing, the data arrangement determination unit 112 enumerates the data servers 2 having a sufficient free space. For these data servers 2, the data arrangement determination unit 112 generates a list of combinations for 1 to the total number of nodes. The data arrangement determination unit 112 sorts the generated list in ascending order of the number of nodes, and acquires a performance in a case where the data server 2 in the list performs request processing related to the processing from the top of the list, from the response time prediction unit 111. In a case where the acquired performance satisfies the request, the data arrangement determination unit 112 determines these data servers 2 as the data arrangement destinations, and in a case where the acquired performance does not satisfy the request, the data arrangement determination unit 112 determines whether the performance satisfies the request for the data server 2 in a next row of the list.

### [B-2] Operation Example

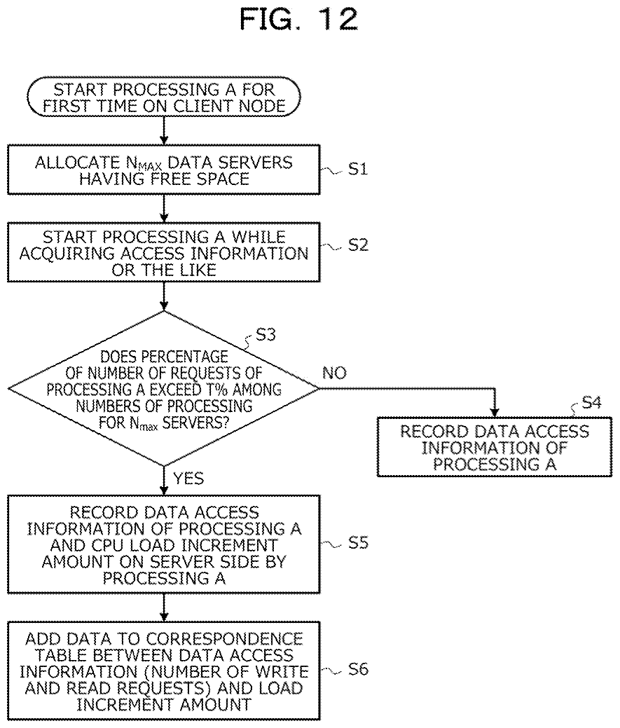

The initial processing in the parallel data store system 100 illustrated in FIG. 4 will be described with reference to a flowchart (operations S1 to S6) illustrated in FIG. 12.

When the processing A (for example, see FIG. 7) is started for the first time on the client node 3, the management server 1 allocates Nₘₐₓ data servers 2 having a free space (operation S1).

While acquiring access information, a communication processing response time, or a data processing response time from the client node 3 and the data server 2, the management server 1 causes the client node 3 and the data server 2 to start the processing A (operation S2).

The management server 1 determines whether a percentage of the number of requests of the processing A exceeds a threshold T % among the numbers of processing of the Nₘₐₓ servers (operation S3).

When the percentage of the number of requests of the processing A does not exceed the threshold T % among the numbers of processing of the Nₘₐₓ servers (see NO route in operation S3), the management server 1 records data access information of the processing A (operation S4). The initial processing in the parallel data store system 100 ends.

By contrast, when the percentage of the number of requests of the processing A exceeds the threshold T % among the numbers of processing of the Nₘₐₓ servers (see the YES route in operation S3), the management server 1 records the data access information of the processing A and the CPU load increment amount on the data server 2 side by the processing A (operation S5).

The management server 1 adds data to a correspondence table between the data access information (for example, the number of write and read requests) and the load increment amount (operation S6). The initial processing in the parallel data store system 100 ends.

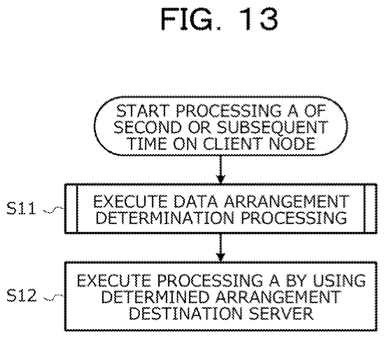

The processing of the second or subsequent time executed in the parallel data store system 100 illustrated in FIG. 4 will be described below with reference to a flowchart (operations S11 and S12) illustrated in FIG. 13.

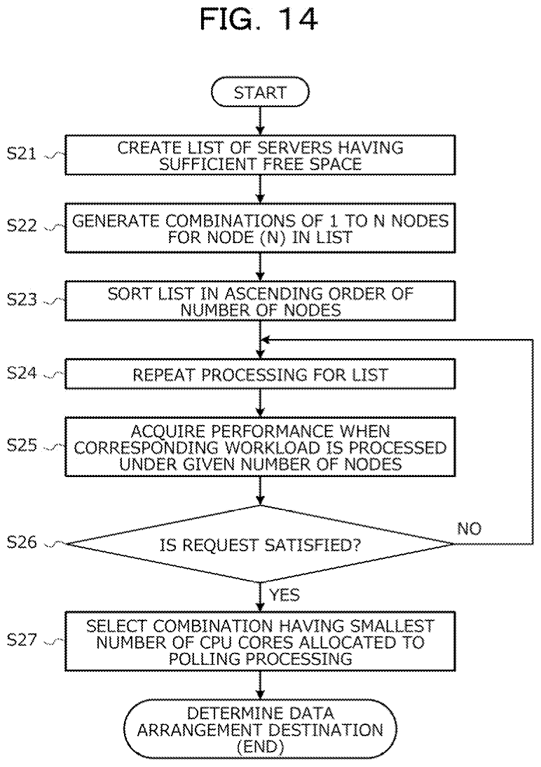

When the processing A is started for the second or subsequent time on the client node 3, the management server 1 executes data arrangement determination processing (operation S11). Details of the data arrangement determination processing performed in operation S11 will be described later using FIG. 14.

The management server 1 causes the client node 3 to execute the processing A by using the determined data server 2 as the arrangement destination (operation S12). The processing of the second or subsequent time in the parallel data store system 100 ends.

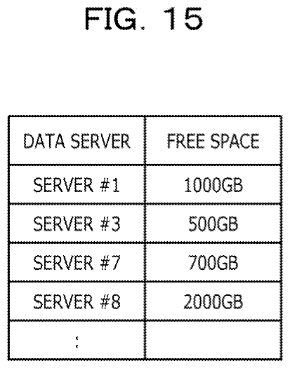

The data arrangement determination processing in the parallel data store system 100 illustrated in FIG. 4 will be described with reference to a flowchart (operations S21 to S26) illustrated in FIG. 14. FIG. 15 is a table exemplifying the data server 2 having a sufficient free space in the parallel data store system 100.

The data arrangement determination unit 112 of the management server 1 creates a list of data servers 2 having a sufficient free space (operation S21). According to the example illustrated in FIG. 15, servers #1, #3, #7, and #8 are represented in a list format as the data servers 2 having the sufficient free space.

For the N nodes in the created list, the data arrangement determination unit 112 generates combinations of 1 to N nodes (operation S22).

The data arrangement determination unit 112 sorts the list in ascending order of the number of nodes (operation S23).

The data arrangement determination unit 112 executes repetitive processing on the list (operation S24).

The data arrangement determination unit 112 acquires a performance when a corresponding workload is processed under the given number of nodes (operation S25).

The data arrangement determination unit 112 determines whether the acquired performance satisfies the request (operation S26).

When the performance does not satisfy the request (see NO route in operation S26), the processing returns to operation S24.

By contrast, when the performance satisfies the request (see YES route in operation S26), the data arrangement determination unit 112 determines the combination of the data servers 2 having the smallest number of CPU cores allocated to the polling processing as the data arrangement destination (operation S27). The data arrangement determination processing ends.

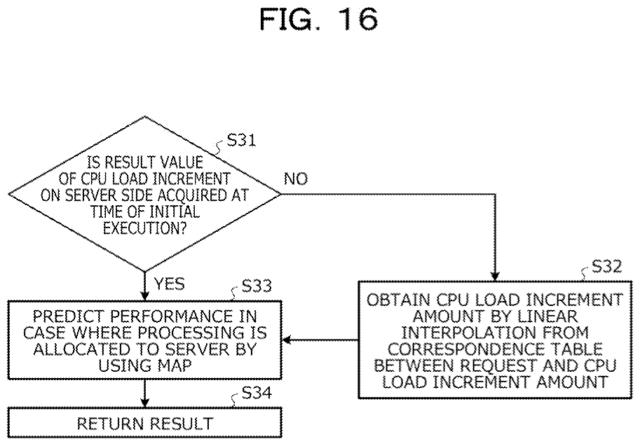

The performance prediction processing in the parallel data store system 100 illustrated in FIG. 4 will be described with reference to a flowchart (operations S31 to S34) illustrated in FIG. 16.

At the time of the initial execution, the response time prediction unit 111 of the management server 1 determines whether the result value of the CPU load increment on the data server 2 side is acquired (operation S31).

At the time of the initial execution, in a case where the result value of the CPU load increment on the data server 2 side is not acquired (see NO route in operation S31), the response time prediction unit 111 obtains a CPU load increment amount by linear interpolation from the correspondence table between the request and the CPU load increment amount (operation S32). The processing proceeds to operation S33.

By contrast, when the result value of the CPU load increment on the data server 2 side is acquired at the time of the initial execution (see the YES route in operation S31), the response time prediction unit 111 predicts the performance in a case where the processing is allocated to the data server 2 by using the performance prediction map (operation S33).

The response time prediction unit 111 returns a prediction result to the data arrangement determination unit 112 (operation S34). The performance prediction processing ends.

### [C] Effects

According to the parallel data store processing method, the parallel data store system 100, and the program in the embodiment described above, for example, the following operation effects may be obtained.

Each of the plurality of data servers 2 stores the first response time desired for the communication processing and the second response time desired for the data processing, executed by the data server in relation to first processing by the client node 3. At the time of execution of second processing different from the first processing by the client node 3, the management server 1 acquires a third response time desired for the communication processing and a fourth response time desired for the data processing, which are related to the second processing, in each of the plurality of data servers 2 based on the first response time and the second response time. Based on the acquired third response time and fourth response time, the management server 1 determines combinations of the data servers used to execute the second processing. Among the determined combinations, the management server 1 selects a combination that satisfies a response time to be satisfied by the second processing and that has the smallest number of processor cores allocated to the communication processing of the data server.

Accordingly, it is possible to improve the communication speed in the parallel data store. For example, the performance degradation due to an increase in the number of data servers 2 (for example, scalability) is suppressed. Since the number of data servers 2 with which the client node 3 communicates may be limited for each processing, the number of communication paths is reduced, and the number of desired polling processing is also reduced. In a case where the parallel data store system 100 is large-scaled, it becomes possible to achieve a corresponding performance improvement.

Each of the plurality of data servers 2 acquires the first response time desired for the communication processing and the second response time desired for the data processing, executed by the data server 2 in relation to the first processing by the client node 3, and transmits the acquired first response time and second response time to the management server 1. Accordingly, it is possible to efficiently acquire the first response time and the second response time.

Each of the plurality of data servers 2 acquires the number of requests per unit time and the processor use rate when the second processing is executed for the first time. When the second processing is executed for the second time, the management server 1 acquires a third response time desired for the communication processing and a fourth response time desired for the data processing related to the second processing in each of the plurality of data servers 2 based on the first response time, the second response time, the number of requests per unit time, and the processor use rate. Accordingly, when the second processing is executed for the second time, it is possible to appropriately acquire the third response time desired for the communication processing and the fourth response time desired for the data processing related to the second processing.

The communication processing is communication processing by polling that exclusively uses the processor core. Accordingly, it is possible to reduce the number of desired polling processing and to increase the scale without sacrificing the speedup of the polling model.

One of the plurality of data servers 2 functions as the management server 1. Accordingly, since a dedicated server as the management server 1 does not have to be provided, the installation cost of the parallel data store system 100 may be reduced, and a communication load between the data server 2 and the management server 1 may be reduced.

### [D] Others

The disclosed technique is not limited to the embodiment described above, and may be carried out by variously modifying the technique within a range not departing from the gist of the present embodiment. Each of the configurations and each of the processing of the present embodiment may be selectively employed or omitted as desired or may be combined as appropriate.

Although, in the above-described embodiment, the parallel data store system 100 includes the management server 1 that functions as the response time prediction unit 111 and the data arrangement determination unit 112 separately from the data server 2 or the client node 3, the configuration is not limited to this. At least one of the data server 2 and the client node 3 in the parallel data store system 100 may have functions as the response time prediction unit 111 and the data arrangement determination unit 112.

Accordingly, it is possible to achieve an effect that hardware resources may be effectively used, in addition to the effect that may be achieved by the above-described embodiment, since the management server 1 does not have to be provided separately from the data server 2 or the client node 3.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A parallel data store system comprising:
a plurality of data servers; and
a management server coupled to the plurality of data servers and a client node, and the management server comprising:
a first memory, and
a first processor coupled to the first memory and configured to:
store a correspondence relationship between a first response time desired for communication processing and a second response time desired for data processing, executed by each of the plurality of data servers in relation to first processing by the client node,
acquire, at a time of execution of second processing different from the first processing by the client node, a third response time desired for communication processing and a fourth response time desired for data processing, which are related to second processing, in each of the plurality of data servers, based on the first response time and the second response time,
determine combinations of the data servers used to execute the second processing, based on the acquired third response time and fourth response time, and
select a combination that satisfies a response time to be satisfied by the second processing and that includes a smallest number of processor cores allocated to the communication processing of a data server of the plurality of data servers, among the determined combinations.

2. The parallel data store system according to claim 1,
wherein each of the plurality of data servers is configured to include
a second memory, and
a second processor coupled to the second memory and configured to acquire the first response time desired for the communication processing and the second response time desired for the data processing, executed in the data server in relation to the first processing by the client node, and
transmit the acquired first response time and second response time to the management server.

3. The parallel data store system according to claim 1,
wherein each of the plurality of data servers is configured to include
a second memory, and
a second processor coupled to the second memory and configured to
acquire a number of requests per unit time and a processor use rate when the second processing is executed for a first time, and
wherein the first processor is configured to acquire the third response time and the fourth response time in each of the plurality of data servers, based on the first response time, the second response time, the number of requests per unit time, and the processor use rate, when the second processing is executed for a second time.

4. The parallel data store system according to claim 1, wherein the communication processing is communication processing by polling that exclusively uses the processor core.

5. The parallel data store system according to claim 1, wherein one of the plurality of data servers functions as the management server.

6. A non-transitory computer-readable recording medium storing a program that causes a computer to execute a process, the computer being included in a management server coupled to the plurality of data servers and a client node, the process comprising:
storing a correspondence relationship between a first response time desired for communication processing and a second response time desired for data processing, executed by each of the plurality of data servers in relation to first processing by the client node;
acquiring, at a time of execution of second processing different from the first processing by the client node, a third response time desired for communication processing and a fourth response time desired for data processing, which are related to second processing, in each of the plurality of data servers, based on the first response time and the second response time;
determining combinations of the data servers used to execute the second processing, based on the acquired third response time and fourth response time; and
selecting a combination that satisfies a response time to be satisfied by the second processing and that includes a smallest number of processor cores allocated to the communication processing of a data server of the plurality of data servers, among the determined combinations.

7. The non-transitory computer-readable recording medium according to claim 6, the process further comprising:
receiving, from each of the plurality of data servers, the first response time desired for the communication processing and the second response time desired for the data processing, executed in the data server in relation to the first processing by the client node.

8. The non-transitory computer-readable recording medium according to claim 6, wherein the process acquires the third response time and the fourth response time in each of the plurality of data servers, based on the first response time, the second response time, a number of requests per unit time, and a processor use rate, when the second processing is executed for a second time, the number of requests per unit time and the processor use rate being acquired, when the second processing is executed for a second time, by the each of the plurality of data servers.

9. The non-transitory computer-readable recording medium according to claim 6, wherein the communication processing is communication processing by polling that exclusively uses the processor core.

10. The non-transitory computer-readable recording medium according to claim 6, wherein one of the plurality of data servers functions as the management server.

11. A parallel data store method of a parallel data store system to which a management server, a plurality of data servers, and a client node are coupled, the parallel data store method comprising:
storing a correspondence relationship between a first response time desired for communication processing and a second response time desired for data processing, executed by each of the plurality of data servers in relation to first processing by the client node,
acquiring, at a time of execution of second processing different from the first processing by the client node, a third response time desired for communication processing and a fourth response time desired for data processing, which are related to second processing, in each of the plurality of data servers, based on the first response time and the second response time,
determining combinations of the data servers used to execute the second processing, based on the acquired third response time and fourth response time, and
selecting a combination that satisfies a response time to be satisfied by the second processing and that includes a smallest number of processor cores allocated to the communication processing of a data server of the plurality of data servers, among the determined combinations, by a first processor of the management server.

12. The parallel data store method according to claim 11, further comprising:
acquiring the first response time desired for the communication processing and the second response time desired for the data processing, executed in the data server in relation to the first processing by the client node, and
transmitting the acquired first response time and second response time to the management server, by a second processor of the data server.

13. The parallel data store method according to claim 11, further comprising:
acquiring a number of requests per unit time and a processor use rate when the second processing is executed for a first time, by a second processor of the data server, and
wherein the first processor acquires the third response time and the fourth response time in each of the plurality of data servers, based on the first response time, the second response time, the number of requests per unit time, and the processor use rate, when the second processing is executed for a second time.

14. The parallel data store method according to claim 11, wherein the communication processing is communication processing by polling that exclusively uses the processor core.

15. The parallel data store method according to claim 11, wherein one of the plurality of data servers functions as the management server.
